(19) United States
(12) Patent Application Publication
(10) Pub. No.: US 2020/0036152 A1
(43) Pub. Date: Jan. 30, 2020

(54) LASER AMPLIFIER SYSTEM

(71) Applicant: TRUMPF LASER GMBH, Schramberg (DE)

(72) Inventors: Aleksander Budnicki, Gundelfingen (DE); Raphael Scelle, Villingen-Schwenningen (DE)

(21) Appl. No.: 16/590,774

(22) Filed: Oct. 2, 2019

Related U.S. Application Data
(63) Continuation of application No. PCT/EP2018/057928, filed on Mar. 28, 2018.

(30) Foreign Application Priority Data
Apr. 5, 2017 (DE) 102017107358.2

(51) Int. Cl. H01S 3/00; H01S 3/23; H01S 3/02; H01S 3/067

(52) U.S. Cl. CPC H01S 3/0057; H01S 3/2316; H01S 3/2375; H01S 3/06754; H01S 3/025

(57) ABSTRACT

A laser amplifier system includes: a fiber-laser pre-amplifier system for pre-amplifying initial laser pulses and outputting pre-amplified laser pulses; an intermediate-compressor for temporally partially compressing the pre-amplified laser pulses; a solid-state post-amplifier for post-amplifying temporally partially compressed pre-amplified laser pulses and for outputting post-amplified laser pulses; and a post-compressor for temporally compressing the post-amplified laser pulses to generate the output laser pulses.

### CROSS REFERENCE TO RELATED APPLICATIONS

This application is a continuation of and claims priority under 35 U.S.C. § 120 from PCT Application No. PCT/EP2018/057928 filed on Mar. 28, 2018, which claims priority from German Application No. 10 2017 107 358.2, filed on Apr. 5, 2017. The entire contents of each of these priority applications are incorporated herein by reference.

### TECHNICAL FIELD

The present disclosure relates to ultrashort pulse (USP) laser systems, in particular USP laser systems for amplifying pulsed laser radiation to high power and/or high pulse energy. Furthermore, the subject matter of the present disclosure concerns processes for dispersion compensation in such laser systems.

### BACKGROUND

In high-power high-energy USP laser systems, fiber-laser amplifiers can be used as input stage and solid-state based amplifiers as post-amplifiers, see e.g. “Industrial grade fiber-coupled laser systems delivering ultrashort high power pulses for micromachining” in Proc. of SPIE Vol. 9741 975109-1. Initial laser pulses coupled into the fiber-laser amplifier are amplified in the fiber and at the same time temporally stretched. The initial laser pulses can, for example, be seed pulses of a seed-laser. Such pre-amplified laser pulses are amplified to the desired high output pulse energy in the solid-state based post-amplifier. After amplification, the post-amplified laser pulses are compressed temporally and output as output laser pulses (also referred to herein as output pulses).

The post-amplified laser pulses are usually compressed by a downstream compressor system that largely compensates the dispersion added in connection with the amplification in order to set the desired ultra-short pulse duration for the output laser pulses.

The dispersion to be compensated can include the dispersion introduced in the amplification media as well as the dispersion added to the seed-pulses in a stretcher system preceding the amplification and causing an additional laser pulse stretching. If a stretcher system is used, temporally stretched seed-pulses are coupled into the fiber as initial laser pulses. The pulse stretcher reduces the pulse peak power inter alia in the amplification media and is the basis of the so-called “chirped pulse amplification” (CPA).

Stretcher and compressor systems can generally include dispersive optical elements such as (diffraction) gratings, volume Bragg gratings, prisms, grisms, and/or dispersive mirrors such as Gires-Tournois-interferometer mirrors (GTI mirrors) used in transmission or reflection and can be configured, for example, as grating stretcher and grating compressor setups.

### SUMMARY

Grating compressors allow the compensation of large dispersion values, such as that can occur when amplifying to high power and/or high pulse energy, but grating compressors are sensitive to changes in the beam position after the solid-state amplifier and misalignment of the compressor due to high thermal loads, because changes in the path within the grating compressor may lead to a change in dispersion and, thus, to a change in pulse duration. In order to avoid high intensities on the gratings of a grating compressor, large beam diameters in the grating compressor are used for high-power high-energy USP laser systems, which, in turn, leads to large and expensive optical gratings being used.

In some amplifier systems for pulsed lasers, compression of amplified laser pulses takes place in a compressor that follows the amplification process and that is usually operated in vacuum. In order not to have to change the settings of the compressor, an adjustment compressor is additionally provided for the adjustment of the dispersion. The adjustment compressor is used for an efficient fine adjustment of the pulse duration of the pulses output, in particular while maintaining the initially stretched pulses for the amplification. The adjustment compressor provides less than 20% and sometimes less than 10% of the compression rate of the compressor.

In general, an aspect of this disclosure is directed to a compression concept that allows the use of smaller gratings and that is more tolerant to changes in the beam path of the amplified laser beam.

In general, in another aspect, a laser amplifier system has a two-stage compressor system for outputting output laser pulses by amplifying initial laser pulses. The laser amplifier system includes a fiber-laser pre-amplifier unit for pre-amplifying coupled-in initial laser pulses and for outputting pre-amplified laser pulses, an intermediate-compressor stage for temporally partially compressing the pre-amplified laser pulses, a solid-state post-amplifier unit for post-amplifying temporally compressed pre-amplified laser pulses and for outputting post-amplified laser pulses, and a post-compressor stage for temporally compressing the post-amplified laser pulses to generate the output laser pulses.

In general, in another aspect, a method for amplifying laser pulses includes the following steps: providing a seed-laser pulse source unit for generating seed-laser pulses to be amplified as a basis for initial laser pulses, pre-amplifying the initial laser pulses with a fiber pre-amplifier unit for generating pre-amplified laser pulses, partially compressing the pre-amplified laser pulses, post-amplifying partially compressed pre-amplified laser pulses with a solid-state post-amplifier unit, and compressing the post-amplified laser pulses.

In some embodiments, the fiber laser pre-amplifier unit is configured for gain factors of ≥3 dB of laser pulses with a spectral width ≥1 nm and an intermediate pulse energy ≥0.5 μJ (after pre-amplification) at a mode size in the amplification fiber of the last amplifier stage of a mode field diameter (MFD) ≥10 μm, where the MFD is twice the radius at which the intensity drops to 1/e². In some embodiments, the solid-state post-amplifier unit is configured for gain factors ≥3 dB of laser pulses with pulse lengths ≥1 ps at a mode size in the solid-state amplifier of MFD ≥100 μm. Furthermore, the solid-state post-amplifier unit can be configured for output pulse energies ≥100 μJ.

The embodiments disclosed herein may have the following advantages, among others. For example, in some embodiments, for partial compression at still relatively low intensities, smaller and, thus, less expensive gratings can be used for the intermediate-compressor. Due to the partial compression, smaller gratings can also be used for the compressor after the solid-state amplifier, because the compression factor of the second compressor is smaller than when using a single compressor after the solid-state amplifier. This reduces the overall cost of the laser amplifier system, especially for the implementation of the compressor concept.

In this context, partial compression is generally understood to mean that, after the fiber-laser pre-amplifier unit, the compression is spectrally not performed to the maximum practically possible, but that the pulse length is only partially reduced. A two-stage compression reduces the pulse length in the first stage, for example, by at least 30%, preferably by 50% or more. For example, at least 75% of the pulse length can be removed. However, the pulse peak power should not become too high due to the damage thresholds of optical elements and possible disadvantageous nonlinearities, which, among other things, determine the solid-state minimum input pulse length as a lower limit for the extent of partial compression.

Due to the high power, it may be advantageous to use reflective gratings for the second compressor downstream of the solid-state amplifier, as these offer higher efficiency than transmission gratings. However, it can be technologically demanding to produce large gratings. In practice, large gratings have corresponding unevenness, which can have a negative effect on the beam quality. In general, the larger the grating, the greater the unevenness that needs to be accepted. Due to the pre-compression, smaller gratings can be used, which reduces the influence on the beam quality from the gratings of the post-compressor stage. For the pre-compression itself, small beam diameters and, thus, small gratings or transmission gratings can be used, which also have little effect on the beam quality.

The sensitivity of a compressor to the beam position of the post-amplified laser pulses increases with the compression factor, e.g. the size of the grating compressor. As a fiber laser system is in principle more stable in terms of beam position than a solid-state amplifier (especially at high powers and, thus, high thermal load in the solid-state amplifier), it may be advantageous to reduce the compression factor after the solid-state amplifier and to compress the pulses as far as possible before the solid-state amplifier so that, in the solid-state amplifier, the intensities generated are not too high.

In order to adjust (especially optimize) the pulse duration or the pulse shape of the output laser pulses, it is useful to adjust the dispersion properties of the compressor and optionally of the stretcher. In fiber-lasers, a chirped fiber Bragg grating is often used for stretching, which typically offers less freedom to adjust the dispersion than the compressor. Therefore, the dispersion is often adjusted by manipulating the compressor system. In high performance USP systems with only one compressor after the solid-state amplifier, such adjustment of the sole compressor system is demanding due to the high performance in the compressor. On the other hand, in a two-stage compressor system, as disclosed herein, it may be possible to carry out the dispersion adjustments within the first compressor at significantly lower power or at least to make a partial contribution to the dispersion adjustment.

In addition, a two-stage compressor setup with the same size (e.g., the same dispersion parameters) of the output compressor can allow higher temporal stretch factors for the fiber pre-amplifier unit and/or the solid-state post-amplifier unit, so that in particular higher pulse energies can be extracted from the fiber stage and from the laser amplifier system as a whole.

In general, the concepts disclosed herein and relating to reducing the compression factors of post-compressor stages can be used in amplifier systems other than those based on spectral broadening during post-amplification alone.

In particular, the concepts disclosed herein are applicable in amplifier systems using different amplifier media (e.g., fiber amplifiers for the fiber-laser pre-amplifier purity and rod or disk amplifiers for the solid-state post-amplifier unit).

### BRIEF DESCRIPTION OF THE DRAWINGS

FIG. 1 is a schematic that illustrates an exemplary laser amplifier system with a two-stage compressor setup.

FIG. 2 is a schematic that illustrates an exemplary low-repetitive laser system with several rod post-amplifiers.

FIG. 3 is a schematic that illustrates an exemplary low-repetitive laser system with a multi-pass disk post-amplifier.

### DETAILED DESCRIPTION

The aspects described herein are partly based on the realization that a two-stage compressor system with a first compressor between, e.g., a fiber-laser and a solid-state amplifier (herein referred to as intermediate-compressor stage) and a second compressor after the solid-state amplifier (herein referred to as post-compressor stage) can reduce the compression factor of the second compressor. Accordingly, the compressor may be made less sensitive to changes in the beam position and, thus, less sensitive to a misalignment caused by a beam position. In particular, a grating compressor configured as a post-compressor stage has a reduced beam diameter in the spectrally disperse (split-up) direction due to the smaller compression factor, so that in this direction smaller (and cheaper) optical gratings can be used for the compression of the output pulses with high powers and/or pulse energies.

In other words, the required stretch factors for different amplifier stages can allow fulfilling a subsequently lower required stretch factor by a partial compression, e.g., a compression between the different amplifier stages, thereby reducing the compression being needed at the end. This can simplify the setup of the second or post-compressor stage.

An example of an attractive approach for a high-power high-energy USP laser system is the combination of a fiber-laser as input stage with a solid-state amplifier. The fiber-laser is flexible and, e.g., very stable with regard to its output beam position. Compared to a pure fiber-laser system, the solid-state amplifier allows higher average powers and pulse energies (peak powers).

Prior the amplification of the pulses in the fiber-laser system, the pulses are typically stretched in time to reduce the peak power and must therefore be compressed again temporally. A complete pre-compression of the pulses directly after the fiber-laser input stage is usually not possible, because then intensities present in the solid-state amplifier would be too high and, for example, nonlinear effects or damages to the amplifier medium (a solid-state crystal, e.g. in the form of a rod, slab or a disk) or optical components such as a Pockels cell can occur. Therefore, an amplification of stretched pulses in the solid-state amplifier and, thus, a compression after the solid-state amplifier is also performed.

Compared to fiber-based amplifiers, solid-state amplifiers typically operate with significantly larger mode fields and, thus, with the same pulse duration at lower intensities and nonlinearities. For this reason, a solid-state amplifier requires a lower stretching than a fiber-laser. This makes it possible, for example, to compress the pulses in two stages, e.g. with a first compressor directly after the fiber-laser and a second compressor after the solid-state-laser. The advantages of such a two-stage compressor approach are explained herein.

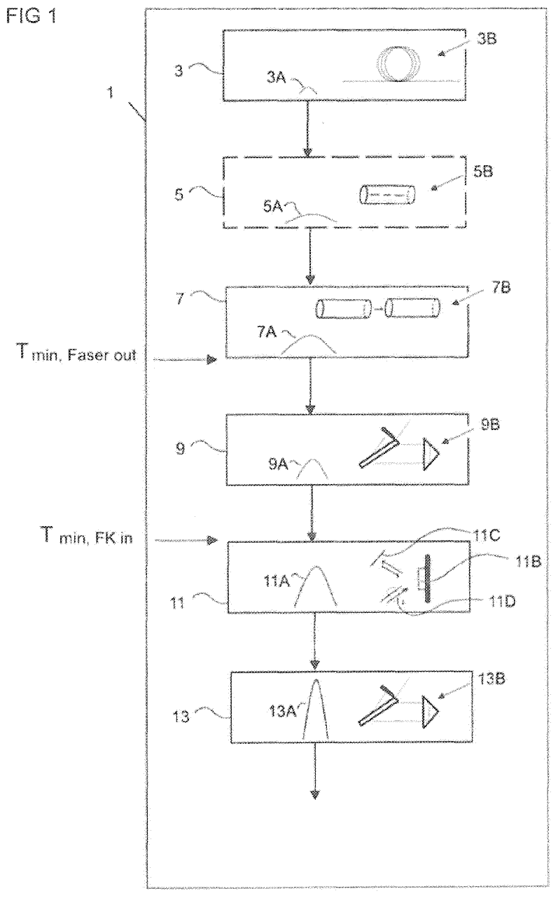

In connection with FIG. 1, the amplification process and the associated components of the exemplary(USP) laser amplifier system 1 are explained below.

The laser amplifier system 1 includes a seed-laser pulse source unit 3, optionally a stretcher system 5 upstream of the amplification process, a fiber-laser pre-amplifier unit 7, an intermediate-compressor stage 9, a solid-state post-amplifier unit 11, and a post-compressor stage 13. In general, the fiber-laser pre-amplifier unit 7 and the solid-state post-amplifier unit 11 are configured in such a way that the fiber-laser pre-amplifier unit 7 requires a higher stretch factor than the solid-state post-amplifier unit 11 for the respective amplification processes in the operating range of the laser amplifier system 1.

In FIG. 1, the laser pulses exiting the respective component are schematically indicated as intensity curves over time. In the laser amplifier system 1, the amplification process is set in such a way, for example, that the spectrum of a laser pulse essentially is neither spectrally broadened when passing through the solid-state post-amplifier unit 11 (or possibly when passing through the entire laser amplifier system 1), nor spectrally narrowed due to “gain narrowing.”

The seed-laser pulse source unit 3 provides a sequence of seed-laser pulses 3A for the subsequent amplification. The seed-laser pulses 3A have a seed pulse length in the range from, e.g., nanoseconds to femtoseconds and are generated with a repetition rate in the kHz range to the MHz range. The seed-laser pulse source unit 3 is shown in FIG. 1 as an exemplary fiber-oscillator 3B. The fiber-oscillator 3B includes, for example, an ytterbium-doped, fiber-based and mode-locked femtosecond (fs)-oscillator for the generation of laser pulses with pulse lengths of, e.g., some 100 fs at wavelengths around 1030 nm, pulse energies in the range of, e.g., 20 pJ to 100 pJ and repetition rates in the range of, e.g., less than 50 MHz such as 20 MHz or 10 MHz or several 100 kHz. In addition to the ytterbium-doped fibers mentioned above, other rare-earth doped fibers alternatively can be used such as, e.g., thulium-doped and erbium-doped fibers for wavelengths of about 1 μm and holmium-doped fibers for wavelengths of about 2 Furthermore, solid-state oscillators (e.g. rod-lasers, slab-lasers, or disk-lasers) or diode-lasers or microchip-lasers can be used to generate the seed-laser pulses 3A. Furthermore, a part of the generation of the seed-laser pulses 3A can be due to a spectral broadening in a fiber upstream of the fiber-laser pre-amplifier unit.

The optional stretcher system 5 (also referred to as a pulse length stretcher) allows the pulse length of the laser pulses, e.g., the initial laser pulses 5A, coupled into the fiber-laser pre-amplifier unit 7 to be set in such a way that the pulse length at the output of the fiber-laser pre-amplifier unit 7 is not less than the minimum fiber output pulse length T_{min,Fiber out} (described below). The stretcher system 5 can be configured as a chirped-fiber-Bragg grating stretcher 5B, for example. Furthermore, stretchers, such as stretchers based on diffraction gratings, can be used. The optional stretcher system 5 can be configured separately or as part of the seed-laser pulse source unit 3.

The pulse length stretching over a dispersive fiber or a dispersive optical setup (e.g. grating stretcher) can stretch the pulse length of the seed-laser pulses, e.g., up to 100 ps, up to 1 ns, or up to several ns, before the pulses are provided to the fiber pre-amplifier system 5 as initial laser pulses 5A. In some embodiments, a first pre-amplification process can take place before the pulse length stretching.

With reference to the example of an embodiment in FIG. 1, the amplification process begins with the coupling of the initial laser pulses 5A into the fiber-laser pre-amplifier unit 7. Two amplification fibers 7B are shown as examples in FIG. 1. The amplification process in an amplification fiber 7B is characterized by a mode size in the amplification fiber 7B, a maximum laser pulse energy/pulse peak power present in the amplification fiber 7B and/or a material property of the amplification fiber 7B, such as an optical nonlinearity, as well as the fiber minimum output pulse length T_{min,fiber out} for the pre-amplified laser pulses 7A. It should be noted that in the amplification concept disclosed herein, the solid-state post-amplifier unit 11 has a minimum solid-state input pulse length T_{min,FK in} which is required for stable operation of the laser amplifier system 1, in particular unaffected by nonlinearities. This pulse length is shorter than the minimum fiber output pulse length T_{min,fiber out}.

For example, the fiber-laser pre-amplifier unit 7 may include a sequence of fiber-laser amplifier stages optically coupled in series, whereby the input laser pulses 5A in the fiber-laser amplifier stages are sequentially amplified and output as an intermediate pulse sequence including the pre-amplified laser pulses 7A having an intermediate pulse length. The intermediate pulse length is greater than the minimum fiber output pulse length T_{min,fiber out}, but also greater than it would be necessary considering the required minimum solid-state input pulse length T_{min,FK in}.

For example, two amplification fibers 7B are shown in FIG. 1. Exemplary amplification fibers allow a gain factor ≥3 dB, e.g. from 20 dB to 30 dB (e.g., a factor 100 to 1000 on a non-logarithmic scale), without reducing the repetition rate for generating intermediate pulse energies ≥0.5 μJ (after pre-amplification) at a mode size in the amplification fiber (e.g., in the last amplification fiber of multi-stage fiber amplifier sequence) of MFD ≥10 μm. The pulse lengths of the pre-amplified laser pulses 7A are above or comparable to the minimum fiber output pulse length T_{min,fiber out}, which is required for stable operation of the fiber-laser pre-amplifier unit 7, especially with respect to nonlinearities. Exemplary values of the minimum output pulse length T_{min,fiber out} are 10 ps to several 100 ps.

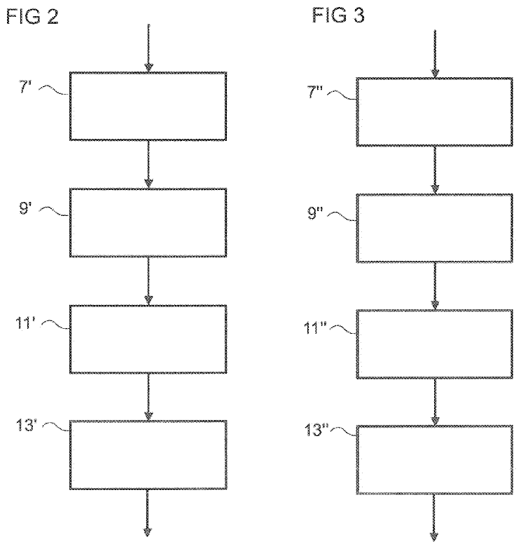

An example of an amplification fiber 7B is a “single clad—single mode” step index fiber, which is pumped, e.g., with a single mode pump unit. Taking into account the losses due to isolator elements, several such “single clad—single mode” step-index fibers can achieve pulse energies of up to 1 μJ, starting from the seed pulses, e.g. low repetitive at a power of 500 mW and a repetition rate of 500 kHz. See also the description in connection with FIGS. 2 and 3. In general, very different parameters can be achieved depending on the seed energy and seed frequency. Herein “low repetitive” typically means pulse repetition rates in the range of 10 MHz or less, such as 1 MHz, 100 kHz or 50 kHz down to 20 kHz or 10 kHz or less, while “high repetitive” typically means pulse repetition rates in the range of 10 MHz and more, such as in the range up to 100 MHz or more, such as up to 1 GHz.

Alternatively or additionally, a pulse selection unit can be provided before, inside, or after the fiber-laser pre-amplifier unit 7 to reduce the pulse repetition rate in order to more efficiently amplify single selected laser pulses in the fiber-laser pre-amplifier unit 7 and/or the solid-state post-amplifier unit 11. Typically, fiber-coupled acousto-optical modulators (AOM) or free-beam AOM are used. The use of electro-optical modulators (EOM) is also possible.

As a result of the pre-amplification, pre-amplified laser pulses 7A are output, which are then fed to the intermediate-compressor stage 9 for temporal compression in order to shorten the laser pulses to values above or equal to the minimum solid state input pulse length T_{min,FK in}. For example, in the intermediate-compressor stage 9, the laser pulses are first recompressed in time to pulse lengths of, e.g., about 10 ps or about 100 ps. The first temporal recompression can be done, e.g., with a grating compressor 9B that includes a transmission grating as shown schematically in FIG. 1. For example, a volume-Bragg-grating (e.g., a chirped volume-Bragg-grating) or GTI-mirror can be used alternatively or additionally, which permits a beam-stable intermediate-compressor stage 9 due to its compact design, because only the coupling-in needs to be made stable.

In some implementations, the first temporal partial compression is set in such a way that as much dispersion as possible is compensated before the post-amplification, without the post-amplification being adversely affected, but at the same time, the remaining dispersion to be compensated may be reduced as far as possible. Accordingly, in some implementations, the intermediate-compressor stage 9 is designed in such a way that the pulse length of the pre-amplified laser pulses 7A, which is greater than or equal to the minimum fiber output pulse length T_{min,fiber out}, is compressed to a new pulse length that is smaller than the minimum fiber output pulse length T_{min,fiber out} and greater than or in the range of the minimum solid state input pulse length T_{min,FK in}. The first temporal partial compression of the laser pulses may also account for dispersion caused by optical dispersive elements that follow in the continuing beam path.

The intermediate-compressor stage 9 outputs partially compressed pre-amplified laser pulses 9A. The temporally partially compressed pre-amplified laser pulses 9A are fed to the solid-state post-amplifier unit 11 for post-amplification. Accordingly, the solid-state post-amplifier unit 11 outputs post-amplified laser pulses 11A.

The solid-state post-amplifier unit 11 may include at least one solid-state-laser amplifier stage, which is designed as a rod-laser amplifier stage, slab-laser amplifier stage, or disk-laser amplifier stage. Furthermore, the at least one solid-state-laser amplifier stage can optionally be configured as a linear amplifier or a regenerative amplifier. In particular, the solid-state post-amplifier unit 11 may include a sequence of solid-state-laser amplifier stages optically coupled in series, whereby laser pulses are sequentially amplified in the solid-state-laser amplifier stages and output as post-amplified laser pulses 11A. For example, in some implementations, the solid-state post-amplifier unit has a gain factor ≥3 dB for laser pulses with pulse lengths ≥1 ps with a mode size in the solid-state amplifier (solid-state laser medium) of MFD ≥100 μm. In some implementations, the solid-state post-amplifier unit can be configured for output pulse energies ≥100 μJ

The solid-state post-amplifier unit 11 can, for example, be operated as a low repetitive amplifier stage in the repetition range from, e.g., 20 kHz to 1 MHz (or up to several MHz, e.g. 10 MHz). The solid-state post-amplifier unit 11 can include optical components such as a solid-state laser medium 11B and, in particular, beam guidance optics such as deflecting mirrors 11C as well as optionally an optical switching-element (pulse selection unit) such as a Pockels cell 11D interacting with a polarizer (schematically indicated in FIG. 1). Usually at least one of the optical components is assigned a maximum pulse power that determines the solid-state minimum input pulse length T_{min,FK i}.

The maximum pulse power is, e.g., given by a maximum tolerable nonlinearity assigned to the optical parameters. The maximum pulse power depends, for example, on the mode size, the frequency dependency of the amplification in one of the optical elements, in particular in a solid-state laser medium, such as a rod-laser solid-state laser medium, slab-laser solid-state laser medium, or disk-laser solid-state laser medium, and/or the influence on the beam quality by the nonlinearity, for example the formation of a spatial chirp by self-phase modulation. The frequency dependence of the amplification refers here to an undesired influence on the spectrum of the pulses, which can lead to a reduced pulse quality. Furthermore, the maximum pulse power can be expressed using a damage threshold (especially surface damage threshold) assigned to a mode size in one of the optical elements, such as, e.g., the Pockels cell 11D or other optical switching element, or by the onset of a degradation of the optical parameters.

With pulse energies of, e.g., 100 μJ or more (e.g. up to the mJ-range), the post-amplified laser pulses 11A in the post-compressor stage 13 are temporally recompressed to a desired (usually the minimal possible) pulse length. For example, pulse lengths of several 100 fs to several 100 ps can be achieved. The recompression can be achieved, e.g., with a grating compressor 13B, as schematically indicated in FIG. 1. The recompression can also account for subsequent optical dispersive elements that follow in the downstream beam path. For example, a volume Bragg grating (e.g., a chirped volume Bragg grating) or GTI mirror can be used for recompression.

The temporally recompressed post-amplified laser pulses can be provided as output laser pulses 13A of the post-compressor stage 13 for workpiece processing in a machine tool, e.g., for micro-material-processing, with the desired pulse length and corresponding pulse peak powers.

FIGS. 2 and 3 are schematics illustrating that the concept of two-stage compression can be implemented in laser systems with different objectives depending on the type of amplifier stages. Thus, pulses with very different pulse duration and pulse intensity can be obtained.

FIG. 2 is a schematic illustrating an exemplary low repetitive laser system with several rod amplifiers and FIG. 3 is a schematic illustrating an exemplary low repetitive laser system with a multi-pass disk amplifier.

With reference to FIG. 2 and starting from exemplarily a fiber oscillator with, for example, an integrated pulse stretcher, the fiber-laser pre-amplifier unit 7′ can include one or more (e.g. two) 10 μm-MFD fibers that, for example, output pulses with a pulse duration of 500 ps and a pulse energy of 1 μJ (e.g., an output power of 0.01 W) at a repetition rate of 10 kHz. In an intermediate compressor 9′, the pulses are compressed to a pulse length of 10 ps (with essentially the same pulse energy and output power of 0.01 W) and then are amplified in several rod amplifiers 11′ to a pulse energy of, e.g., 1 mJ (with essentially the same pulse length of 10 ps), so that the output power is 10 W. The pulse energy is then amplified to a pulse energy of, e.g., 1 mJ (with essentially the same pulse length of 10 ps). In a post-compressor 13′, the 1 mJ pulses are compressed to a pulse duration of, e.g., 1 ps (with essentially the same output power of 10 W).

Again, starting from exemplarily a fiber oscillator with, for example, an integrated pulse stretcher, the fiber-laser pre-amplifier unit 7″ shown schematically in FIG. 3 can include one (or more) 50 μm-MFD-rod fibers, which, for example, output pulses with a pulse duration of 1 ns and a pulse energy of 100 μJ (i.e., an output power of 100 W) at a repetition rate of 1 MHz. In an intermediate compressor 9″, the pulses are compressed to a pulse length of 100 ps (at essentially the same pulse energy and output power of 100 W). The partially compressed pulses pass through a disk amplifier 11″ several times and are amplified to a pulse energy of, e.g., 3 mJ (with essentially the same pulse length of 100 ps), so that the output power of the disk amplifier 11″ is 3 kW. In a post-compressor 13″, the 3 mJ pulses are compressed to a pulse duration of, e.g., 1 ps (with essentially the same output power of 3 kW).

In summary, with the fiber-laser pre-amplifier unit and the solid-state post-amplifier unit and the two-stage compression, high pulse peak powers or very high pulse energies can be generated for a very short pulse duration. In order to ensure a sufficient pulse quality, for example, not to exceed damage thresholds, and/or not to cause any or at least no significant spectral broadening during the amplification process, the pulse lengths, the optical media used of, e.g., amplification fibers and solid-state laser media as well as their amplification factors can be selected accordingly. For example, B-integrals in the range of 30 rad and smaller (e.g., 5 rad and smaller or, e.g., 3 rad and smaller) assigned to the initial laser pulses 5A and/or the pre-amplified laser pulses 7A can thus be used. Accordingly, B-integrals assigned to the post-amplified laser pulses 11A can also be used in the range of 30 rad and smaller (e.g., 10 rad and smaller or 5 rad and smaller or, e.g., 3 rad and smaller). For the exiting free beam, B-integrals of the post-amplified pulses in the range of 10 rad and smaller, for example, can be given at least for the fundamental mode.

The concept of two-stage compression disclosed herein also includes multi-stage compression if, for example, a first compression is split between amplification fibers and/or the second compression is done with several compressors.

The concept disclosed herein includes, among other things, also an amplification system based on a diode-laser as a seed-laser pulse source unit with a subsequent spectral broadening in a fiber, a fiber-laser pre-amplifier unit, an intermediate-compressor stage, a solid-state post-amplifier unit, and a post-compressor stage.

It is explicitly emphasized that all features disclosed in the description and/or claims should be considered separate and independent of each other for the purpose of the original disclosure as well as for the purpose of limiting the claimed invention regardless of the feature combinations in the embodiments and/or claims. It is explicitly stated that any indications of ranges or groups of units reveal any possible intermediate value or sub-group of units for the purpose of the original disclosure as well as for the purpose of limiting the claimed invention, in particular also as a limit of a range indication.

What is claimed is:

1. A laser amplifier system comprising a two-stage compressor system, the laser amplifier system comprising:
a fiber-laser pre-amplifier system to pre-amplify initial laser pulses coupled into the fiber-laser pre-amplifier and to output pre-amplified laser pulses;
an intermediate laser pulse compressor to temporally partially compress the pre-amplified laser pulses by at least 30%;
a solid-state post-amplifier to post-amplify temporally partially compressed pre-amplified laser pulses from the intermediate laser pulse compressor as and output post-amplified laser pulses; and
a post laser pulse compressor to temporally compress the post-amplified laser pulses to generate output laser pulses.

2. The laser amplifier system of claim 1, wherein the fiber-laser pre-amplifier system comprises at least one fiber-laser amplifier with an amplification fiber, wherein an amplification process in the amplification fiber requires the pre-amplified laser pulses to have a fiber minimum output laser pulse length, T_{min,fiber out}, and each of the pre-amplified laser pulses comprises a corresponding first pulse length that is greater than or equal to T_{min,fiber out}, and
the intermediate-compressor stage is configured to compress the first pulse lengths of the pre-amplified laser pulses to second pulse lengths, each second pulse length being shorter than T_{min,Fiber out} and is greater than or equal to a solid-state minimum input pulse length, T_{min,FK in}, of the solid-state post amplifier.

3. The laser amplifier system of claim 2, wherein the solid-state post-amplifier comprises optical components and a maximum pulse power is associated with at least one of the optical components, wherein the maximum pulse power determines T_{min,FK in}.

4. The laser amplifier system of claim 3, optical components of the solid-state post-amplifier comprises at least one of a solid-state laser medium, a rod-laser solid-state laser medium, a slab-laser solid-state laser medium, or a disk-laser solid-state laser medium, beam-guiding optics, a mirror, a Pockels cell, a polarizer, or combinations thereof.

5. The laser amplifier system of claim 3, wherein the maximum pulse power is given by at least one of a nonlinearity associated with a mode size, an avoidance of spatial chirp, a frequency dependence of the amplification in at least one of the optical elements, and wherein
a damage threshold that is associated with a mode size in one of the optical elements.

6. The laser amplifier system of claim 1, wherein the intermediate laser pulse compressor comprises an optical grating compressor configured to reflect or transmit incident laser pulses.

7. The laser amplifier system of claim 6, wherein the intermediate laser pulse compressor is configured to partially compress in time the pre-amplified laser pulses by at least 50% of the pulse length.

8. The laser amplifier system of claim 1, wherein
at least one of the intermediate laser pulse compressor and the post laser pulse compressor comprises at least one of a diffraction grating, a volume Bragg grating, a prism, a grism, a Gires-Tournois-interferometer mirror, or combinations thereof.

9. The laser amplifier system of claim 1, wherein
the fiber-laser pre-amplifier system and the solid-state post-amplifier
are configured such that the fiber-laser pre-amplifier system comprises a greater stretch factor than the solid-state post-amplifier.

10. The laser amplifier system of claim 1, wherein the fiber-laser pre-amplifier system is configured to exhibit a gain factor of greater than or equal to 3 dB for laser pulses having a spectral width greater than 1 nm and an intermediate pulse energy greater than or equal to 0.5 μJ at a mode field diameter greater than or equal to 10 μm in an amplification fiber of the fiber-laser pre-amplifier system.

11. The laser amplifier system of claim 1, wherein
the fiber-laser pre-amplifier system comprises at a plurality of fiber-laser amplifier stages optically coupled in series.

12. The laser amplifier system of claim 1, further comprising:
a stretcher system comprising dispersive optical elements connected upstream of the fiber-laser pre-amplifier system, wherein the stretcher system is configured to stretch pulse lengths and reduce a pulse peak power of the initial laser pulses coupled into the fiber-laser pre-amplifier system.

13. The laser amplifier system of claim 12, further comprising a pulse selection positioned upstream of, within, or downstream of the fiber-laser pre-amplifier system.

14. The laser amplifier system of claim 1, wherein
the solid-state post-amplifier comprises at least one solid-state-laser amplifier configured as a rod-laser amplifier, a slab-laser amplifier, or a disk-laser amplifier.

15. The laser amplifier system of claim 14, wherein the at least one solid-state-laser amplifier comprises a linear amplifier or regenerative amplifier.

16. The laser amplifier system of claim 1, wherein the solid-state post-amplifier is configured to exhibit a gain factor of greater than or equal to 3 dB for a laser comprising a pulse length greater than 1 ps at a mode field diameter in the solid-state post-amplifier greater than or equal to 100 μm.

17. The laser amplifier system of claim 1, further comprising a seed-laser pulse source configured to generate a sequence of seed-laser pulses as the initial laser pulses, wherein the seed-laser pulse source is a fiber-oscillator, a diode-laser, a rod-oscillator, or a microchip-laser.

18. The laser amplifier system of claim 1, wherein spectral widths of the post-amplified laser pulses are substantially in a range of spectral widths of the temporally partially compressed pre-amplified laser pulses.

19. The laser amplification system of claim 1, wherein the solid-state post-amplifier is directly coupled to the intermediate laser pulse compressor to receive the temporally partially compressed pre-amplified laser pulses.

20. A method for amplifying laser pulses, the method comprising:
providing initial laser pulses;
pre-amplifying the initial laser pulses with a fiber pre-amplifier to provide pre-amplified laser pulses;
partially compressing the pre-amplified laser pulses by at least 30% to provide partially compressed pre-amplified laser pulses;
post-amplifying the partially compressed pre-amplified laser pulses with a solid-state post-amplifier to provide post-amplified laser pulses; and
compressing the post-amplified laser pulses.

21. The method of claim 20, comprising reducing a repetition rate of the initial laser pulses before or during pre-amplifying the initial laser pulses.
